(19) United States
(12) Patent Application Publication
(10) Pub. No.: US 2019/0372065 A1
(43) Pub. Date: Dec. 5, 2019

(54) BATTERY PACK

(71) Applicant: HONDA MOTOR CO., LTD., Tokyo (JP)

(72) Inventors: Masao KAWATA, Saitama (JP); Atsushi SAKURAI, Saitama (JP)

(73) Assignee: HONDA MOTOR CO., LTD., Tokyo (JP)

(21) Appl. No.: 16/419,718

(22) Filed: May 22, 2019

(30) Foreign Application Priority Data
May 31, 2018 (JP) 2018-105420

(51) Int. Cl. H01M 2/10; H01M 10/04; H01M 10/613; H01M 10/6568

(52) U.S. Cl. CPC H01M 2/1016; H01M 10/6568; H01M 10/613; H01M 10/0486

(57) ABSTRACT

A battery pack 10 includes a battery module 1, and a battery case 30 that houses the battery module 1. The battery module 1 includes a cell stack 2 configured by stacking a plurality of cells 21, a pair of end plates 3 provided at both end portions of the cell stack 2 in a stacking direction, and a bottom plate 6 on which the cell stack 2 and the pair of end plates 3 are mounted. Plate fixing portions 62 of the bottom plate 6 of the battery module 1 are fixed to a bottom portion 31 of the battery case 30, and the plate fixing portions 62 are disposed in a region of the cell stack 2 and the end plates 3.

### CROSS-REFERENCE TO RELATED APPLICATIONS

This application is based on and claims priority under 35 USC 119 from Japanese Patent Application No. 2018-105420 filed on May 31, 2018.

### TECHNICAL FIELD

The present invention relates to a battery pack mounted on an electric vehicle or the like.

### BACKGROUND ART

In related art, a battery pack is mounted on an electric vehicle or the like. The battery pack is configured by housing a cell stack, which is formed by stacking a plurality of battery cells, in a battery case. For example, JP-A-2013-122818 describes a battery pack in which a cell stack is sandwiched by a pair of end plates from both sides in a stacking direction, and both of the end plates are fixed to a battery case with bolts together with a plate-shaped member provided on a bottom surface of the cell stack.

### SUMMARY

However, in the battery pack of JP-A-2013-122818, since bolt fixing portions of the plate-shaped member provided on the bottom surface of the cell stack protrudes toward an outside of the end plate, an overall size is enlarged and a size of the battery pack is increased.

The present invention provides a battery pack that can be reduced in size while reliably fixing a battery module to a battery case.

### Solution to Problem

An embodiment of the present invention relates to a battery pack, the battery pack includes:

a battery module including a cell stack configured by stacking a plurality of cells, a pair of end plates provided at both end portions of the cell stack in a stacking direction, and a bottom plate on which the cell stack and the pair of end plates are mounted; and

a battery case configured to house the battery module,

in which a plate fixing portion of the bottom plate of the battery module is fixed to a bottom portion of the battery case, and

in which the plate fixing portion is disposed in a region of the cell stack and the pair of end plates.

### Advantageous Effects of Invention

According to one aspect of the present invention, since the plate fixing portion of the bottom plate fixed to the bottom portion of the battery case is disposed in the region of the cell stack and the pair of end plates, the plate fixing portion is prevented from protruding from the region of the cell stack and the pair of end plates. As a result, it is possible to reduce the size of the battery module while reliably fixing the battery module to the battery case.

### BRIEF DESCRIPTION OF DRAWINGS

FIG. 1 is a perspective view of a battery module according to a first embodiment of the present invention with a housed battery pack viewed obliquely from above.

FIG. 2 is a perspective view of the battery module of FIG. 1 as viewed obliquely from below.

FIG. 3 is a cross-sectional view showing a fixing structure of the battery module and the battery case of FIG. 1.

FIG. 4 is a cross-sectional view showing a fixing structure of a first modification.

FIG. 5 is a cross-sectional view showing a fixing structure of a second modification.

FIG. 6 is a cross-sectional view showing a fixing structure of a third modification.

FIG. 7 is a cross-sectional view of the battery pack according to the first embodiment of the present invention.

FIG. 8 is a partial cross-sectional view of a battery pack according to a second embodiment of the present invention.

FIG. 9 is a partial cross-sectional view of a battery pack according to a third embodiment of the present invention.

### DESCRIPTION OF EMBODIMENTS

Embodiments of a battery pack of the present invention will be described below with reference to the drawings.

### First Embodiment

<Battery Pack>

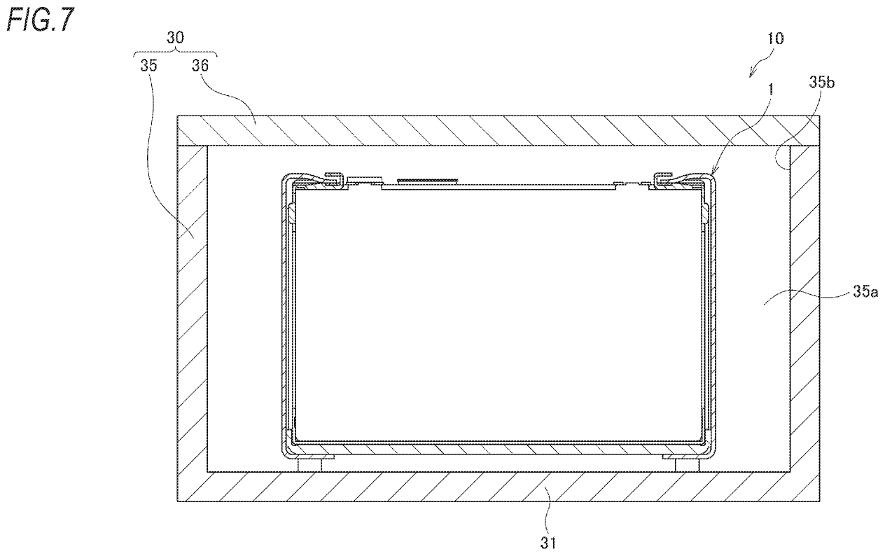

First, a battery pack according to a first embodiment of the present invention will be described with reference to FIG. 7.

As shown in FIG. 7, a battery pack 10 according to the present embodiment includes a battery module 1, and a battery case 30 that houses the battery module 1.

<Battery Case>

The battery case 30 includes a case body 35 in which a module housing portion 35a is formed, and a case cover 36 that seals an opening portion 35b of the case body 35. By fixing the battery module 1 and a bottom portion 31 of the case body 35, the battery module 1 is housed in the module housing portion 35a of the battery case 30. A fixing structure of the battery module 1 and the battery case 30 will be described in detail later.

<Battery Module>

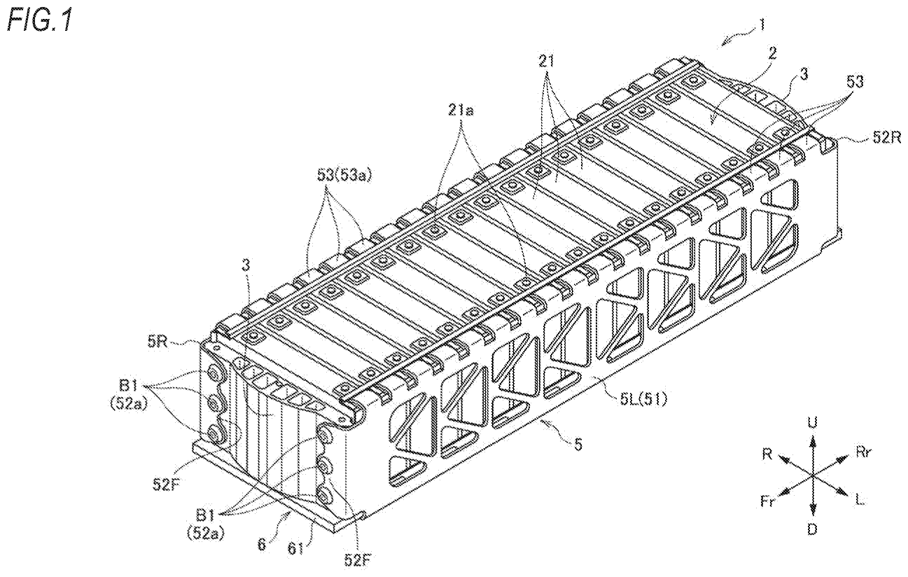

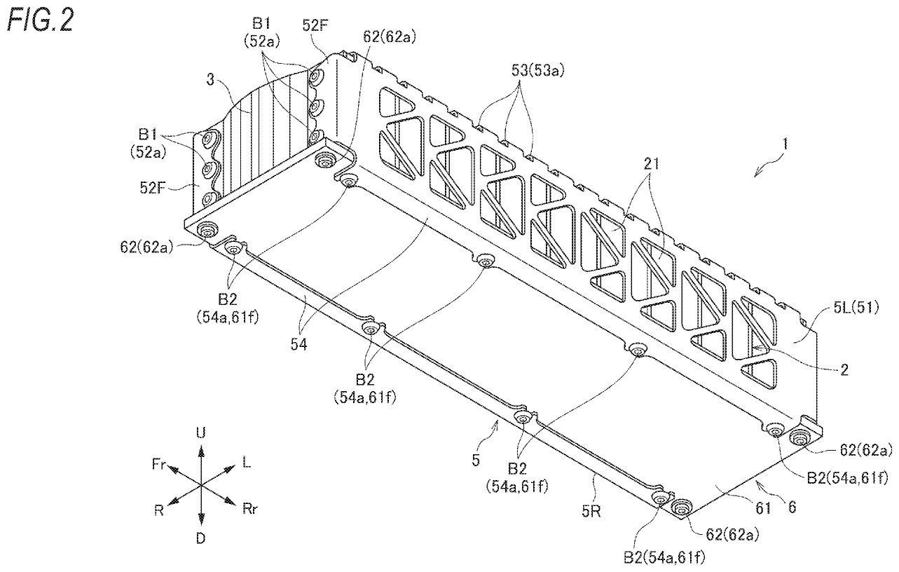

As shown in FIGS. 1 to 3, the battery module 1 includes: a cell stack 2 being configured by stacking a plurality of cells 21 in a front-rear direction and having a front surface, a rear surface, a left surface, a right surface, an upper surface, and a lower surface; a pair of end plates 3 disposed on the front surface and the rear surface of the cell stack 2 respectively; side plates 5 connecting the pair of end plates 3; and a bottom plate 6 disposed on the lower surface of the cell stack 2. The side plates 5 include a right side plate 5R disposed on the right surface of the cell stack 2 and a left side plate 5L disposed on the left surface of the cell stack 2.

In the present specification or the like, in order to simplify and clarify the description, a stacking direction of the cells 21 is defined as the front-rear direction, and directions orthogonal to the stacking direction of the cells 21 are defined as a left-right direction and an upper-lower direction, which are independent from a front-rear direction of a product on which the battery module 1 is mounted. In other words, in a case where the battery module 1 is mounted on a vehicle, the stacking direction of the cells 21 may coincide with a front-rear direction of the vehicle, may be an upper-lower direction or a left-right direction of the vehicle, or may be a direction inclined from these directions. In the drawings, a front side of the battery module 1 is denoted by Fr, a rear side by Rr, a left side by L, a right side by R, an upper side by U. and a lower side by D, respectively.

(Cell Stack)

The cell stack 2 is configured by alternately stacking a plurality of cells 21 and insulating members (not shown) in the front-rear direction. The pair of end plates 3 are disposed on the front surface and the rear surface of the cell stack 2, respectively, and the bottom plate 6 is disposed on the lower surface of the cell stack 2. The right side plate 5R and the left side plate 5L are arranged on the left and right surfaces of the cell stack 2 in an insulated state with small gaps therebetween, respectively.

It is known that the cells 21 expand due to temperature change and aging degradation. Each of the cells 21 has a rectangular parallelepiped shape whose length in the upper-lower direction is longer than the length in the front-rear direction and whose length in the left-right direction is longer than the length in the upper-lower direction. Therefore, areas of the front surface and the rear surface of the cell 21 are greatly larger than areas of the left surface, the right surface, the upper surface, and the lower surface, and left-right center portions and upper-lower center portions on the front surface and the rear surface of the cell 21 are likely to expand.

A plurality of bus bars (not shown), that are electrically connected to terminals 21a of the cells 21 respectively, are arranged on the upper surface of the cell stack 2. The bus bars include some for connecting the terminals 21a of the cells 21 to each other and some for connecting the terminals 21a of the cells 21 to terminals for external connection (not shown). In a case where a load is applied from the battery module 1 to the bus bars, connection failure may occur based on a relative positional deviation between the bus bars and the terminals. Therefore, it is desirable to reduce the load applied from the battery module 1 to the bus bars as much as possible.

(End Plates)

The pair of end plates 3 respectively abut the front surface and the rear surface of the cell stack 2, and receive a load in the cell stacking direction of the cell stack 2 (hereinafter referred to as “cell thickness constraint reactive force” as appropriate). A load in the cell stacking direction of the cell stack 2 is mainly caused by expansion of the cell 21 due to temperature change or aging degradation, and as described above, since the left-right center portions and the upper-lower center portions on the front surface and the rear surface of the cell 21 are likely to expand, a large load is applied to the left-right center portions and the upper-lower center portions of the end plates 3.

Since the end plates 3 receives a large load in the cell stacking direction from the cell stack 2, inner surfaces of the end plates 3 abutting the cell stack 2 are flat, whereas outer surfaces of the end plates 3 without abutting the cell stack 2 have a shape bulging outward.

(Side Plates)

The left side plate 5L and the right side plate 5R are formed by pressing a metal plate material, and respectively include: side plate bodies 51 along the left surface or the right surface of the cell stack 2; front flange portions 52F extending in a direction approaching each other from front ends of the side plate bodies 51 along a front surface of the end plate 3 on the front side; rear flange portions 52R extending in a direction approaching each other from rear ends of the side plate bodies 51 along a rear surface of the end plate 3 on the rear side; upper flange portions 53 extending in a direction approaching each other from upper ends of the side plate bodies 51 along an upper surface of the cell stack 2; and lower flange portions 54 extending in a direction approaching each other from lower ends of the side plate bodies 51 along a lower surface of the bottom plate 6.

Each of the front flange portions 52F and the rear flange portions 52R is provided with a plurality of fastening portions 52a fastened to the end plate 3 on the front side or the end plate 3 on the rear side, via the bolts B1. The fastening portions 52a respectively have round holes through which the bolts B1 are inserted, and by screwing the bolts B1 inserted through the round holes into the end plate 3 on the front side or the end plate 3 on the rear side, the front flange portions 52F and the rear flange portions 52R are fastened to the end plate 3 on the front side or the end plate 3 on the rear side. Thus, the cell stack 2 and the pair of end plates 3 are held in the cell stacking direction by the front flange portions 52F and the rear flange portions 52R of the left side plate 5L and the right side plate 5R.

The upper flange portions 53 and the lower flange portions 54 clamp the cell stack 2 and the bottom plate 6 from the upper and lower directions at a left end portion and a right end portion of the cell stack 2. Thus, since relative position fluctuation of the cell stack 2, the left side plate 5L, the right side plate 5R, and the bottom plate 6 in the upper-lower direction is restricted, even when a vertical load acts on the bottom plate 6, a load applied to the terminals 21a of the cells 21 or the bus bars connecting the cells 21 is reduced.

The upper flange portions 53 have elasticity, and are allowed to elastically deform in the upper-lower direction. Accordingly, when the right side plate 5R and the left side plate 5L are attached to the cell stack 2 and the bottom plate 6 from the left and right directions, the upper flange portions 53 are elastically deformed to facilitate attachment.

Each of the upper flange portions 53 of the present embodiment includes a plurality of elastic pieces 53a arranged in the front-rear direction, and a number and positions of the elastic pieces 53a correspond to a number and positions of the cells 21 stacked in the front-rear direction. As a result, the upper flange portions 53 can elastically hold the plurality of cells 21 individually while having appropriate elasticity.

In the right side plate 5R and the left side plate 5L of the present embodiment, although the upper flange portions 53 are formed integrally with each of the side plate bodies 51, the upper flange portions 53 may also be press-molded separately from the side plate bodies 51, and then integrated with the side plate bodies 51 by welding or crimping.

Each of the lower flange portions 54 is provided with a plurality of fastening portions 54a fastened to the bottom plate 6 via bolts B2. Thus, the left side plate 5L and the right side plate 5R constituting the side plates 5, and the bottom plate 6 are connected integrally.

The fastening portions 54a provided on the lower flange portion 54 of the right side plate 5R are cutout portions that open in the left direction, and the fastening portions 54a provided on the lower flange portion 54 of the left side plate 5L are cutout portions that open in the right direction. Thus, the right side plate 5R and the left side plate 5L can be mounted from the left and right directions in a state where the bolts B2 are temporarily fixed to the bottom plate 6.

(Bottom Plate)

The bottom plate 6 includes a bottom plate body 61 extending along the lower surfaces of the cell stack 2 and the end plates 3, a plurality of plate fixing portions 62 fixed to the battery case 30, guide portions (not shown) protruding from left and right end portions of the bottom plate body 61 and extending along the front-rear direction, and through holes 61f through which the bolt B2 fastened to the fastening portions 54a of the lower flange portions 54 pass, respectively. The bottom plate body 61 has a rectangular shape in plan view, has a length in the front-rear direction substantially equal to a distance between front and rear end portions of the front and rear end plates 3.

(Fixing Structure of Battery Module)

Plate fixing portions 62 serving as fixing portions of the battery module 1 and the battery case 30 are disposed in a region of the cell stack 2 and the front and rear end plates 3. That is, the plate fixing portions 62 do not protrude in either the front-rear direction or the left-right direction from a projection region formed by projecting the cell stack 2 and the front and rear end plates 3 from above.

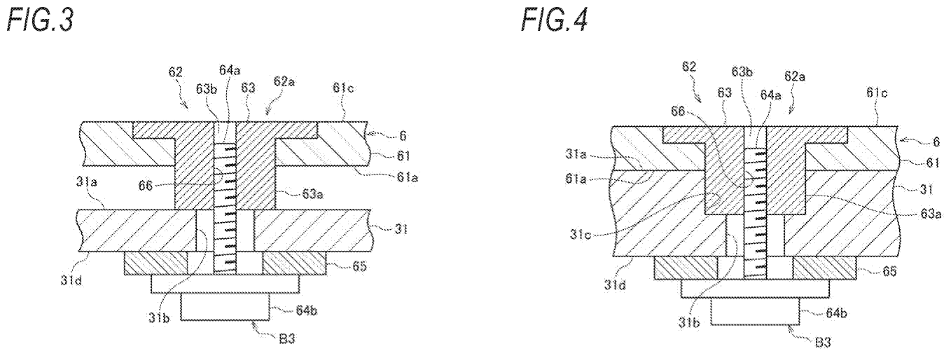

Specifically, the plate fixing portions 62 are hole portions 62a provided at four corners of the bottom plate body 61, and as shown in FIG. 3, a nut 63 having a screw hole (a female screw 66) to be screwed with a bolt B3 is embedded in a non-rotatable manner in each of the holes 62a. Each of the nuts 63 has a protrusion 63a protruding downward from the lower surface 61a of the bottom plate body 61, and the protruding portion 63a is in contact with an upper surface 31a of the bottom portion 31 of the battery case 30. A through hole 31b communicating with the screw hole 63b of the nut 63 is provided on the bottom portion 31 of the battery case 30. A male screw portion 64a of the bolt B3 is screwed into the screw hole 63b of the nut 63 through the through hole 31b from below the bottom portion 31 of the battery case 30. A washer 65 is provided between the head portion 64b of the bolt B3 and the lower surface 31d of the bottom portion 31 of the battery case 30. The bottom plate 6 is fastened and fixed to the bottom portion 31 of the battery case 30 by fastening the bolt B3 to the nut 63.

According to the battery pack 10, the battery module 1 can be fixed to the battery case 30 by a simple operation of fastening the bolts B3 from an outside of the battery case 30, and the battery module 1 can be reduced in size while reliably fixing the battery module 1 to the battery case 30. Moreover, in the battery module 1, since only the plate fixing portions 62 of the bottom plate 6 is fixed to the bottom portion 31 of the battery case 30 by the bolts B3, the battery module 1 is allowed to move in the cell stacking direction due to expansion of the cells 21. Further, since tip ends of the male screw portions 64a of the bolts B3 do not protrude from an upper surface 61c of the bottom plate body 61, interference with the cells 21 or the like disposed on the upper surface 61c of the bottom plate body 61 does not occur.

Next, a modification of the fixing structure of the above-described battery module will be described with reference to FIGS. 4 to 6. Note that only differences from the first embodiment will be described, and the description of the first embodiment is incorporated by denoting the same configurations as those of the first embodiment with the same reference numerals as in the first embodiment.

### First Modification

As shown in FIG. 4, in a fixing structure of a first modification, a recess 31c fitted to the protrusion 63a of the nut 63 is provided on the bottom 31 of the battery case 30. According to the fixing structure of the first modification, when the battery module 1 is fixed to the battery case 30, by respectively fitting the protrusion 63a of the nut 63 into the recess 31c of the battery case 30, the battery module 1 can be easily positioned in the battery case 30.

### Second Modification

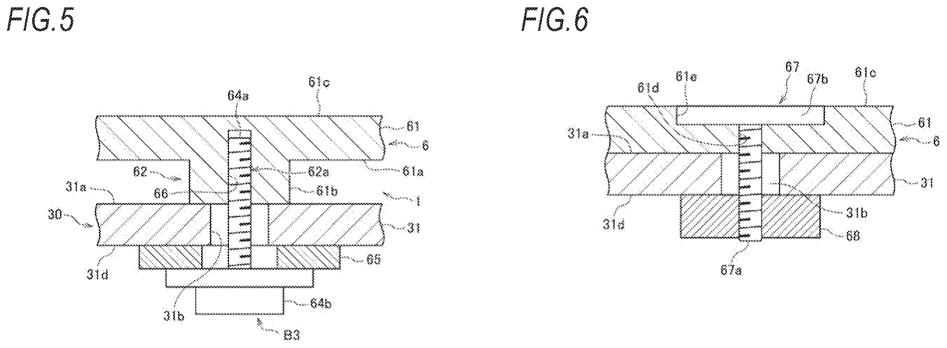

As shown in FIG. 5, in a fixing structure of a second modification, the female screw 66 is formed in the hole 62a of the plate fixing portion 62 of the bottom plate body 61. Specifically, a protrusion 61b protruding downward from the lower surface 61a is provided on the bottom plate body 61, the hole 62a is opened at a center on a lower surface of the protrusion 61b, and the female screw 66 is formed on an inner peripheral portion of the hole 62a. The male screw portion 64a of the bolt B3 is screwed into the female screw 66 through the through hole 31b from below the bottom portion 31 of the battery case 30. According to the fixing structure of the second modification, the battery module 1 can be fixed to the battery case 30 by a simple operation of fastening the bolts B3 from the outside of the battery case 30.

### Third Modification

As shown in FIG. 6, in a fixing structure of a third modification, a bolt 67 is embedded in the bottom plate body 61 in a non-rotatable manner. Specifically, a bolt insertion hole 61d through which a screw portion 67a of the bolt 67 is inserted, and a recess 61e into which a head portion 67b is fitted in a non-rotatable manner are provided on the bottom plate body 61. In a case where the head portion 67b is fitted into the recess 61e, an upper end surface of the head portion 67b is flush with the upper surface 61c of the bottom plate body 61. The screw portion 67a is inserted through the through hole 31b, protrudes downward from the lower surface 31d of the bottom portion 31 of the battery case 30, and is screwed to a nut 68 provided below the bottom portion 31 of the battery case 30. According to the fixing structure of the third modification, the battery module 1 can be fixed to the battery case 30 by a simple operation of fastening the nuts 68 from the outside of the battery case 30.

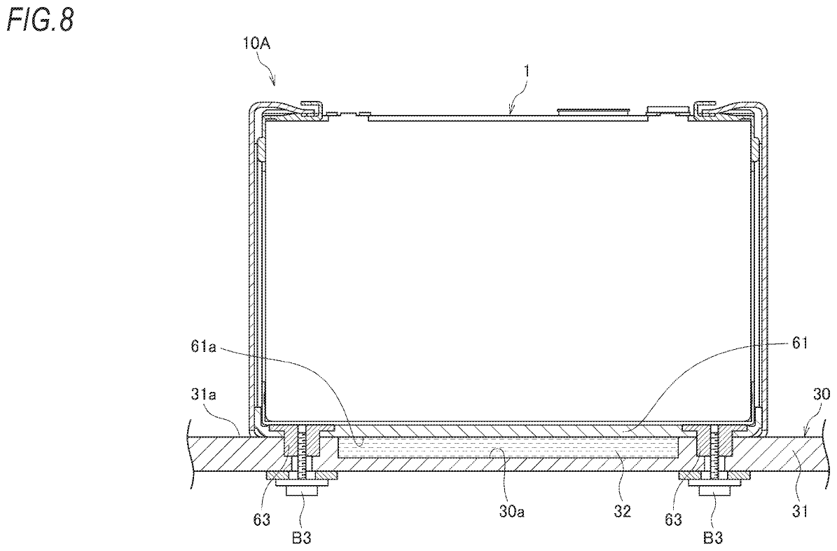

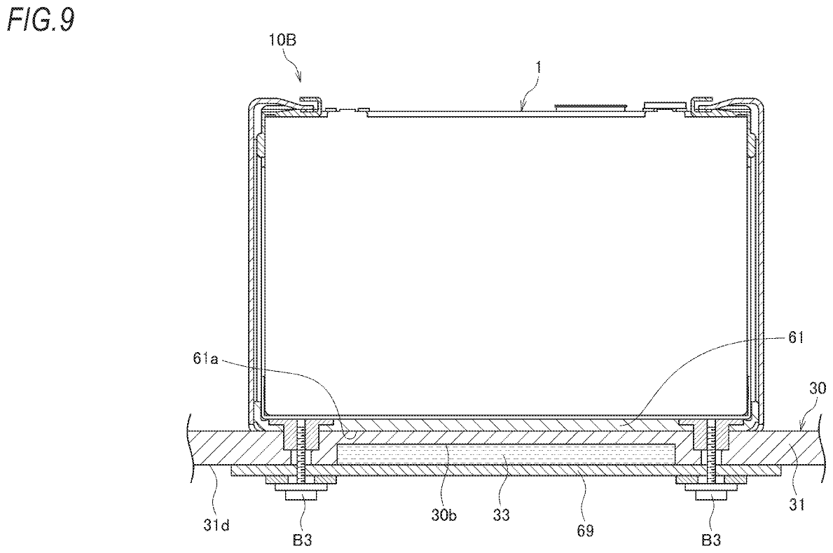

Next, battery packs of other embodiments of the present invention are described with reference to FIGS. 8 and 9. Note that only differences from the first embodiment will be described, and the description of the first embodiment is incorporated by denoting the same configurations as those of the first embodiment with the same reference numerals as in the first embodiment.

### Second Embodiment

As shown in FIG. 8, in a battery pack 10A according to a second embodiment, a recess 30a is provided on the upper surface 31a of the bottom portion 31 of the battery case 30, and a refrigerant flow path 32 is formed by the lower surface 61a of the bottom plate body 61 and the recess 30a of the battery case 30. The fixing structure of the battery module 1 and the battery case 30 is the same as that in FIG. 4. According to the battery pack 10A, it is possible to efficiently cool the battery module 1 by forming the refrigerant flow path 32 without increasing a number of components.

### Third Embodiment

As shown in FIG. 9, in a battery pack 10B according to a third embodiment, a recess 30b is provided on the lower surface 31d of the bottom portion 31 of the battery case 30, and the recess 30b is sealed by a cover member 69. A refrigerant flow path 33 is formed by the recess 30b of the battery case 30 and the cover member 69. The cover member 69 is fastened together with the bottom plate 6 and the battery case 30 by the bolts B3 fixed to the plate fixing portions 62 of the bottom plate 6 from below the bottom portion 31 of the battery case 30. According to the battery pack 10B, it is possible to efficiently cool the battery module 1 by forming the refrigerant flow path 33. Further, since the cover member 69 is fastened together with the bottom plate 6 and the battery case 30, it is not necessary to add a bolt for fixing the cover member 69.

The present invention is not limited to the embodiments described above, and modifications, improvements, or the like can be made as appropriate. For example, the fixing structure of the first to the third modifications may be adopted in the battery packs 10A and 10B of the second and third embodiments.

At least the following matters are described in the present specification. Corresponding components in the above-described embodiments are shown in parentheses, without being limited thereto.

(1) a battery module (the battery module 1) including a cell stack (the cell stack 2) configured by stacking a plurality of cells (the cells 21), a pair of end plates (the end plates 3) provided at both end portions of the cell stack in a stacking direction, and a bottom plate (the bottom plate 6) on which the cell stack and the pair of end plates are mounted; and

A battery pack (the battery pack 10, 10A, or 10B) includes: a battery case (the battery case 30) configured to house the battery module,

in which a plate fixing portion (the plate fixing portions 62) of the bottom plate of the battery module is fixed to a bottom portion (the bottom portion 31) of the battery case, and

in which the plate fixing portion is disposed in a region of the cell stack and the pair of end plates.

According to (1), since the plate fixing portion of the bottom plate fixed to the bottom portion of the battery case is disposed in the region of the cell stack and the pair of end plates, the plate fixing portion is prevented from protruding from the region of the cell stack and the pair of end plates. As a result, it is possible to reduce the size of the battery module while reliably fixing the battery module to the battery case.

(2) In the battery pack according to (1),

the battery module further includes a pair of side plates (the side plates 5L. 5R) arranged to sandwich the cell stack in a direction orthogonal to the stacking direction,

each of the side plates includes:

a side plate body (the side plate body 51);

first fixing pieces (the front flange portion 52F and the rear flange portion 52R) that are bent from the side plate body and respectively extend along outer surfaces of the end plates; and

a second fixing piece (the lower flange portions 54) that is bent from the side plate body and extends along a lower surface of the bottom plate,

the cell stack and the pair of end plates are held in the stacking direction by the first fixing pieces of the pair of side plates,

the cell stack and the bottom plate are held from below by the second fixing pieces of the pair of side plates, and

in the battery module, only the plate fixing portion is fixed to the bottom portion of the battery case.

According to (2), since only the plate fixing portion is fixed to the bottom portion of the battery case, the battery module is allowed to move in the cell stacking direction due to expansion of the cells.

(3) In the battery pack according to (1) or (2),

the plate fixing portion is a hole portion (the hole portions 62a) provided in the bottom plate,

a female screw (the female screws 66) is formed in the hole portion, and

the female screw is fastened by a bolt (the bolts B3) from below the bottom portion of the battery case.

According to (3), after the battery module is housed in the battery case, the battery module can be easily fixed to the battery case from the outside.

(4) In the battery pack according to (1) or (2),

the plate fixing portion is a hole portion (the hole portions 62a) provided in the bottom plate,

a nut (the nuts 63) is embedded in the hole portion, and

the nut is fastened by a bolt (the bolts B3) from below the bottom portion of the battery case.

According to (4), after the battery module is housed in the battery case, the battery module can be easily fixed to the battery case from the outside.

(5) In the battery pack according to (4),

wherein the nut has a protruding portion (the protruding portions 63a) protruding downward from a lower surface (the lower surfaces 61a) of the plate fixing portion, and

a recess (the recesses 31c) configured to be fitted to the protruding portion of the nut is provided on the bottom portion of the battery case.

According to (5), the battery module can be easily positioned with respect to the battery case.

(6) In the battery pack according to any one of (3) to (5).

an end portion of the bolt does not protrude from an upper surface (the upper surface 61c) of the bottom plate.

According to (6), since the end portion of the bolt does not interfere with the cell disposed above the end portion or the like, a height dimension of the battery pack can be reduced.

(7) In the battery pack according to any one of (1) to (6),

a recess (the recess 30a) is provided on an upper surface of the bottom portion of the battery case, and

a refrigerant flow path (the refrigerant flow path 32) is provided by a lower surface (the lower surface 61a) of the bottom plate and the recess of the battery case.

According to (7), it is possible to efficiently cool the battery module by forming the refrigerant flow path without increasing a number of components.

(8) In the battery pack according to any one of (1) to (6),

a recess (the recess 30b) is provided on a lower surface of the bottom portion of the battery case,

the recess is sealed by a cover member (the cover member 69),

a refrigerant flow path (the refrigerant flow path 33) is provided by the recess of the battery case and the cover member, and

the cover member is configured to be fastened together by a bolt (the bolts B3) that is fixed to the plate fixing portion from below the bottom portion of the battery case.

According to (8), it is possible to efficiently cool the battery module by forming the refrigerant flow path without need of a separate bolt for fixing the cover member.

1. A battery pack comprising:
a battery module including a cell stack configured by stacking a plurality of cells, a pair of end plates provided at both end portions of the cell stack in a stacking direction, and a bottom plate on which the cell stack and the pair of end plates are mounted; and
a battery case configured to house the battery module,
wherein a plate fixing portion of the bottom plate of the battery module is fixed to a bottom portion of the battery case, and
wherein the plate fixing portion is disposed in a region of the cell stack and the pair of end plates.

2. The battery pack according to claim 1,
wherein the battery module further includes a pair of side plates arranged to sandwich the cell stack in a direction orthogonal to the stacking direction,
wherein each of the side plates includes:
a side plate body;
first fixing pieces that are bent from the side plate body and extend along outer surfaces of the end plates; and
a second fixing piece that is bent from the side plate body and extends along a lower surface of the bottom plate,
wherein the cell stack and the pair of end plates are held in the stacking direction by the first fixing pieces of the pair of side plates,
wherein the cell stack and the bottom plate are held from below by the second fixing pieces of the pair of side plates, and
wherein in the battery module, only the plate fixing portion is fixed to the bottom portion of the battery case.

3. The battery pack according to claim 1,
wherein the plate fixing portion is a hole portion provided in the bottom plate,
wherein a female screw is formed in the hole portion, and
wherein the female screw is fastened by a bolt from below the bottom portion of the battery case.

4. The battery pack according to claim 1,
wherein the plate fixing portion is a hole portion provided in the bottom plate,
wherein a nut is embedded in the hole portion, and
wherein the nut is fastened by a bolt from below the bottom portion of the battery case.

5. The battery pack according to claim 4,
wherein the nut has a protruding portion protruding downward from a lower surface of the plate fixing portion, and
wherein a recess configured to be fitted to the protruding portion of the nut is provided on the bottom portion of the battery case.

6. The battery pack according to any one of claim 3,
wherein an end portion of the bolt does not protrude from an upper surface of the bottom plate.

7. The battery pack according to any one of claim 1,
wherein a recess is provided on an upper surface of the bottom portion of the battery case, and
wherein a refrigerant flow path is provided by a lower surface of the bottom plate and the recess of the battery case.

8. The battery pack according to any one of claim 1,
wherein a recess is provided on a lower surface of the bottom portion of the battery case,
wherein the recess is sealed by a cover member,
wherein a refrigerant flow path is provided by the recess of the battery case and the cover member, and
wherein the cover member is configured to be fastened together by a bolt that is fixed to the plate fixing portion from below the bottom portion of the battery case.
